(19) United States
(12) Patent Application Publication
(10) Pub. No.: US 2016/0339466 A1
(43) Pub. Date: Nov. 24, 2016

(54) CONCEALED SPRINKLER HEAD COVER

(71) Applicant: PROTECTOR SAFETY IND.,LTD., Taoyuan County (TW)

(72) Inventor: Jung-Wen Chen, Taoyuan County (TW)

(21) Appl. No.: 14/798,196

(22) Filed: Jul. 13, 2015

(30) Foreign Application Priority Data
May 20, 2015 (TW) 104115986

(51) Int. Cl. B05B 15/00; B05B 1/26; A62C 35/68

(52) U.S. Cl. CPC B05B 15/001; A62C 35/68; B05B 1/262

(57) ABSTRACT

A concealed sprinkler head cover includes a cover locked on a sprinkler head body, with the two ends of the cover respectively formed with a clamping portion, and the cover is formed with an upward open groove between the clamping portions, a cap, made of low-temperature metal and adhered to an embedding base, the two ends of the embedding base are respectively formed with a limiting portion, and the embedding base is formed with a downward open groove between the limiting portions, wherein, the clamping portion of the cover clamps the limiting portion of the embedding base, so that the upward open groove and the downward open groove are communicated with each other to form an air flow passage. Based on this, the present invention solves the problem that the heat activation speed of the concealed sprinkler head is hard to be enhanced.

### BACKGROUND OF INVENTION

1. Field of the Invention

The present invention relates generally to a structure of a concealed sprinkler head, and more particularly to a concealed sprinkler head cover.

2. Description of Related Art

As a common knowledge, a conventional fire sprinkler head has a built-in heat-activated glass column. This heat-activated glass column is a hollow cylinder made of glass. The cylinder contains liquid that can easily expand when heated (such as alcohol or glycerol), and the heat-activated glass column is embedded inside the sprinkler head body to seal the fire water supply pipe. When the heat-activated glass column is broken due to thermal expansion of the liquid inside, the fire water supply pipe is open so that water can flow out of the fire sprinkler head.

Common fire sprinkler heads can be largely classified as concealed type, semi-concealed type, and open type. The concealed type is to hide the sprinkler head and the connected fire water supply into the ceiling, and only a head cover is exposed outside the ceiling.

Referring to FIG. 1, in a concealed sprinkler head, the sprinkler head body 10 is housed by the cover, which is made up of a cover body 20 and a cap 30, and hidden inside the ceiling, so as to enhance the overall esthetic appearance of the internal space of the building. To assemble the cover, firstly lock the cover body 20 on the screwing portion 11 of the sprinkler head body 10, and then fix the cap 30 on the bottom of the embedding base 40. The embedding base 40 is spin-locked on the cover body 20 through its convex teeth 41 guided to the tooth thread surface 21 of the cover body 20, so that the sprinkler head body 10 can be hidden inside the ceiling through the cap 30.

Smoke and heat generated by fire reaches the heat-activated glass column 12 through convection of air. When the heat-activated glass column 12 is heated to the activating temperature, the fire water supply pipe is open to spray water. However, although the cover can avoid exposure of the sprinkler head body 10 outside the ceiling, it also blocks the convection of air, and consequently affects the speed of heat activation of the heat-activated glass column 12.

### SUMMARY OF THE INVENTION

In view of this, the objective of the present invention is to overcome the problem of conventional concealed sprinkler heads that the speed of heat activation of the heat-activated glass column cannot be further enhanced due to block of air convection by the cover, and to provide a concealed sprinkler head cover, with technical means including: a sprinkler head body; a cover, locked on the sprinkler head body, the two ends of the cover are respectively formed with a clamping portion, and an upward open groove is formed between the clamping portions of the cover; a cap, made of low-temperature metal and adhered to an embedding base, the two ends of the embedding base are respectively formed with a limiting portion, and a downward open groove is formed between the limiting portions of the embedding base; wherein, the clamping portion of the cover clamps the limiting portion of the embedding base, so that the upward open groove and the downward open groove are communicated to form an air flow passage.

In further implementations, the present invention also includes the following features:

The clamping portion is formed by the fins of the cover on both sides, and the limiting portion is formed by the fins of the embedding base on both sides. The upward open groove is formed between the fins of the cover on both sides, and the downward open groove is formed between the fins of the embedding base on both sides.

The clamping portion is formed on the outside of the fins of the cover on both sides, and the limiting portion is formed on the inside of the fins of the embedding base on both sides.

Or, the clamping portion is formed on the inside of the fins of the cover on both sides, and the limiting portion is formed on the outside of the fins of the embedding base on both sides.

The limiting portion is made up of multiple V-shaped alveoli distributed at intervals, and the clamping portion is formed with snaps that can adjust the height of embedding in the V-shaped alveoli.

The limiting portion is a groove, and the clamping portion is convex teeth that can be embedded into the groove.

The clamping portion and the limiting portion are in corresponding arc, line, U or V shapes.

Based on the above technical means, the present invention provides an advantage over conventional covers in that, through the air flow passage formed between the cover and the embedding base to guide the air flow to the heat-activated glass column, the heat activation speed of the heat-activated glass column can be enhanced, and meanwhile, the present invention can save material to manufacture the cover.

Further benefits and advantages of the present invention will become apparent after a careful reading of the detailed description with appropriate reference to the accompanying drawings.

### BRIEF DESCRIPTION OF THE DRAWINGS

FIG. 1 is a perspective exploded view of a conventional concealed sprinkler head;

FIG. 2 is a perspective exploded view of a preferred embodiment of the present invention;

FIG. 3 is a perspective combined view of FIG. 2;

FIG. 4 is a sectional view of FIG. 3;

FIG. 5a is a partial enlarged view of the first embodiment of the embedding method of the cover and the embedding base;

FIG. 5b is a partial enlarged view of the second embodiment of the embedding method of the cover and the embedding base;

FIG. 6a and FIG. 6b are respectively structural sectional views of the third embodiment of the embedding method of the cover and the embedding base;

FIG. 7a and FIG. 7b are respectively structural sectional views of the fourth embodiment of the embedding method of the cover and the embedding base;

FIG. 8 is a configuration view of the clamping portion and the limiting portion in arc shapes;

FIG. 9 is a configuration view of the clamping portion and the limiting portion in line shapes;

FIG. 10 is a configuration view of the clamping portion and the limiting portion in U shapes;

FIG. 11 is a configuration view of the clamping portion and the limiting portion in V shapes.

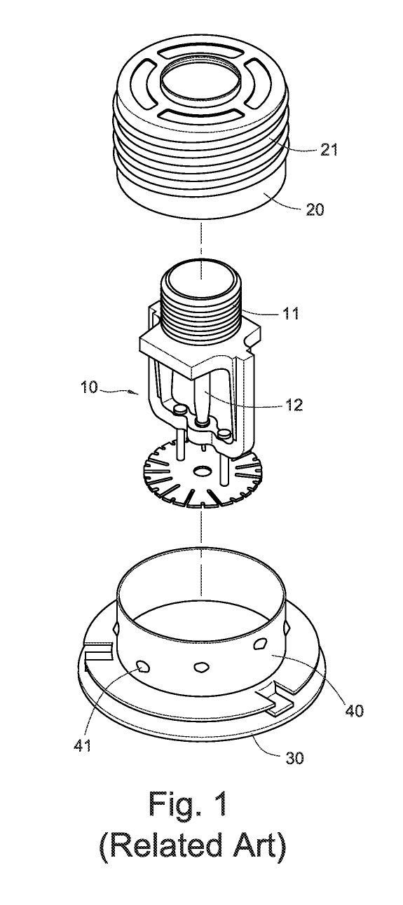

### DETAILED DESCRIPTION OF THE INVENTION

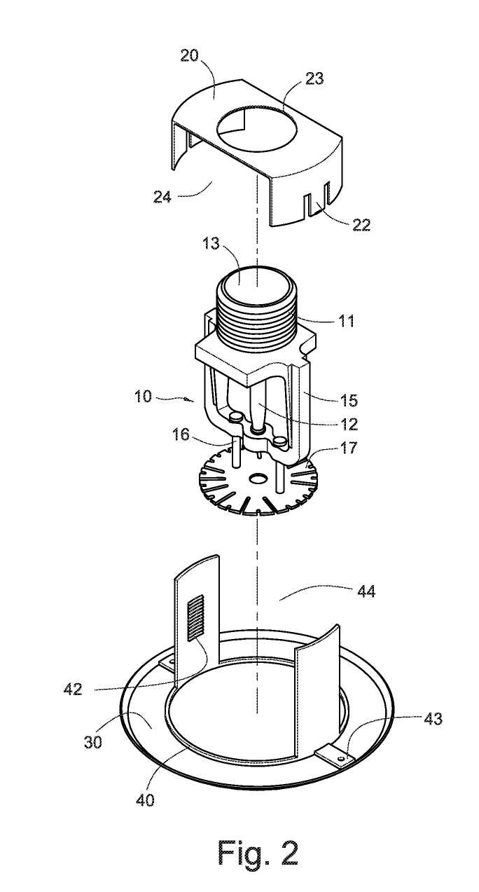

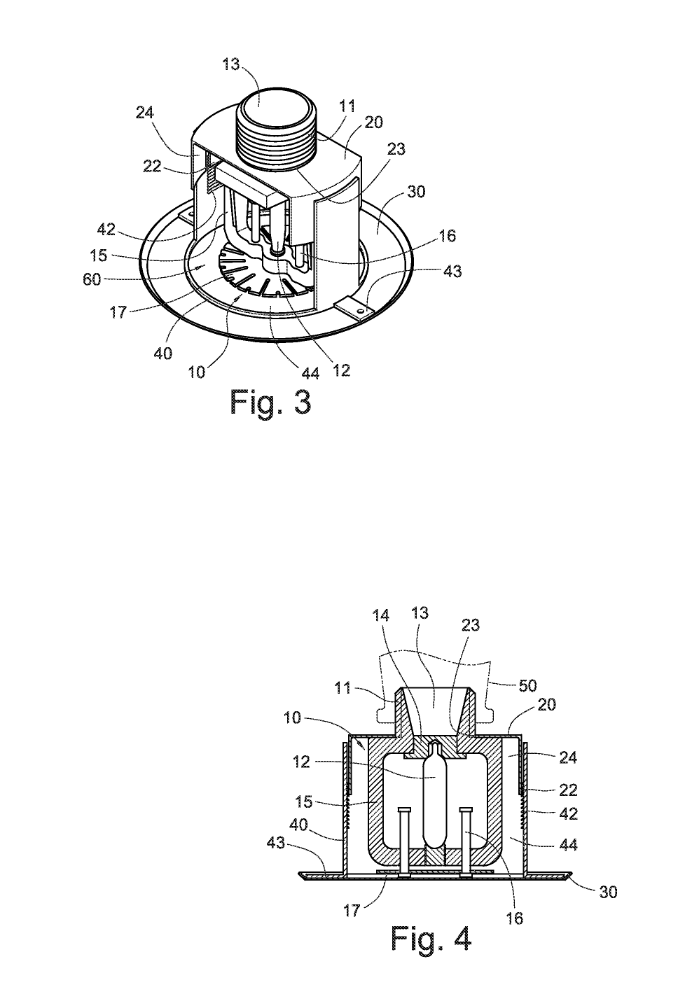

Firstly, referring to FIGS. 2 to 4, which disclose the appearance of a preferred embodiment of the present invention, showing that, the concealed sprinkler head cover provided by the present invention includes a sprinkler head body 10, a cover body 20 and a cap 30, wherein:

In implementation, the sprinkler head body 10 has a screwing portion 11, the sprinkler head body 10 can be locked onto the fire water supply pipe 50 through the screwing portion 11; the inside of the sprinkler head body 10 is formed with a flow passage 13, the flow passage 13 is communicated with the fire water supply pipe 50, so that the fire-fighting water inside the fire water supply pipe 50 can go through the flow passage 13 and flow out of the sprinkler head body 10. Inside the sprinkler head body 10, a water valve 14 is installed. The water valve 14 can control the time of supply of the fire-fighting water inside the fire water supply pipe 50. The bottom end of the water valve 14 is configured with a heat-activated glass column 12. In the normal condition, the heat-activated glass column 12 closes the water valve 14, so that the fire-fighting water fire water supply pipe 50 will not flow out. Symmetric ribs 15 are formed on the two sides of the sprinkler head body 10. The ribs 15 are designed to protect and support the heat-activated glass column 12 fixed inside the sprinkler head body 10. The bottom end of the ribs 15 is provided with a guiding column 16 that can slide along the axis of the flow passage 13. The guiding column 16 is connected to a disc-shaped spoiler 17, so that the fire-fighting water flowing out of the flow passage 13 can form a water curtain through the spoiler 17, and the spraying area of the fire-fighting water can be enlarged.

The cover body 20 is formed with a screw hole 23. The cover body 20 is fixed through the screw hole 23 onto the screwing portion 11 of the sprinkler head body 10. In implementation, the two sides of the cover body 20 are respectively formed with a clamping portion 22. The clamping portion 22 is formed by the fins extending from the two sides of the cover body 20 along the axial direction of the flow passage 13, so that the cover body 20 is in a U shape. In particular, the clamping portion 22 can be snaps formed from the fins on both sides of the cover body 20 by die-pressing. Because the clamping portions 22 offer a resisting force at the point of connection with the cover body 20, the clamping portions 22 can elastically clamps objects. The walls of the cover body 20 between the clamping portions 22 are respectively formed with an upward open groove 24. More precisely, the upward open groove 24 is formed between the fins on both sides of the cover body 20.

In implementation, the cap 30 is fixed on the embedding base 40. Furthermore, the bottom end of the embedding base 40 extends outward along the axial direction of the flow passage 13 to form multiple sticking portions 43. The cap 30 is made of low-temperature metal (e.g. tin) and is fixed on the sticking portions 43 of the embedding base 40 by sticking. When the high temperature caused by fire melts the low-temperature metal, the cap 30 will fall away from the embedding base 40, so that the hot air can contact with the heat-activated glass column 12. When the heat-activated glass column 12 breaks due to the heat, the fire-fighting water inside the fire water supply pipe 50 will flow out of the sprinkler head body 10 through the flow passage 13 and extinguish the fire.

The two sides of the embedding base 40 are respectively formed with a limiting portion 42. In implementation, the limiting portion 42 is made of the fins formed by the two sides of the embedding base 40 extending along the axial direction of the flow passage 13, so that the embedding base 40 is in a U shape. The limiting portion 42 is implemented with multiple V-shaped alveoli distributed at intervals. The clamping portion 22 elastically clamps the V-shaped alveoli on the limiting portion 42 through the snap so that the embedding base 40 is fixed on the cover body 20, and through the snap of the clamping portion 22, the clamping position on the limiting portion 42 can be adjusted. In this way, the cap 30 fixed on the embedding base 40 can match the height of the ceiling to avoid protrusion of the cap 30 out of the ceiling to affect the overall esthetic appearance of the ceiling. The walls of the embedding base 40 between the limiting portions 42 are respectively formed with a downward open groove 44. More precisely, the downward open groove 44 is formed between the fins on both sides of the embedding base 40.

In actual implementation, after the embedding base 40 and the cover body 20 are combined and fixed, the upward open groove 24 and the downward open groove 44 are communicated to each other to form an air flow passage 60. The air flow passage 60 can guide the air flow through the cover body 20 and the embedding base 40. As the sprinkler head body 10 is seated inside the cover body 20 and the embedding base 40, the hot air can be guided through the air flow passage 60 to the heat-activated glass column 12, to increase the contact between the heat-activated glass column 12 and the hot air, and consequently enhance the heat activation speed of the heat-activated glass column 12.

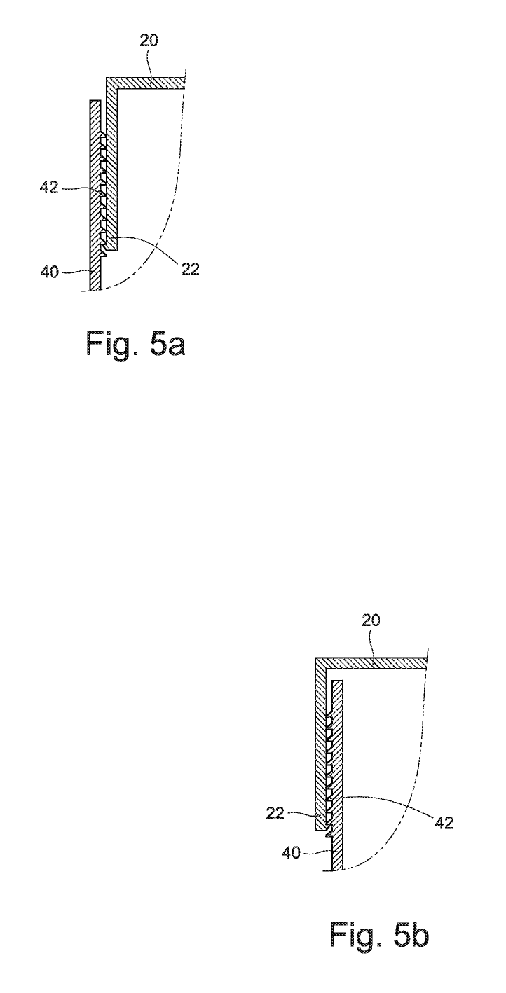

Referring to FIG. 5a and FIG. 5b, the clamping portion 22 can be formed on the outside of the fins on both sides of the cover body 20 (as shown in FIG. 5a), and the limiting portion 42 is formed on the inside of the fins on both sides of the embedding base 40, so that the cover body 20 can clamp the embedding base 40 through the inside of the fins on both sides of the embedding base 40. On the contrary, the clamping portion 22 can be formed on the inside of the fins on both sides of the cover body 20 (as shown in FIG. 5b), and the limiting portion 42 is formed on the outside of the fins on both sides of the embedding base 40, so that the cover body 20 can clamp the embedding base 40 through the outside of the fins on both sides of the embedding base 40.

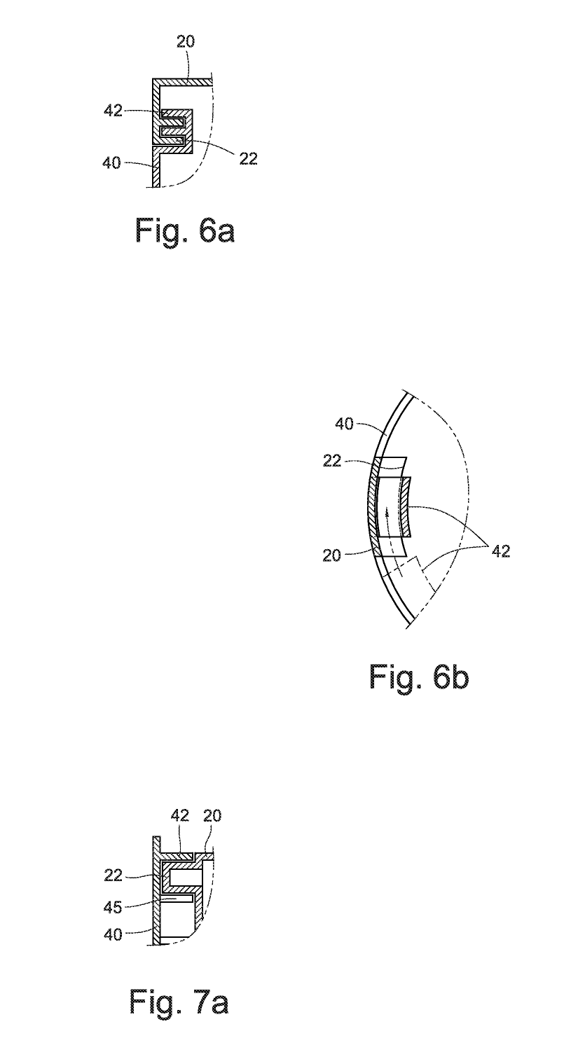

Referring to FIG. 6a and FIG. 6b, the clamping portion 22 can be inner groove formed by the fins on both sides of the cover body 20 extending inward, and the limiting portion 42 can be outer groove formed by the fins on both sides of the embedding base 40 extending outward. The limiting portion 42 of the embedding base 40 is combined with the clamping portion 22 by turning, so that the embedding base 40 is fixed on the cover body 20.

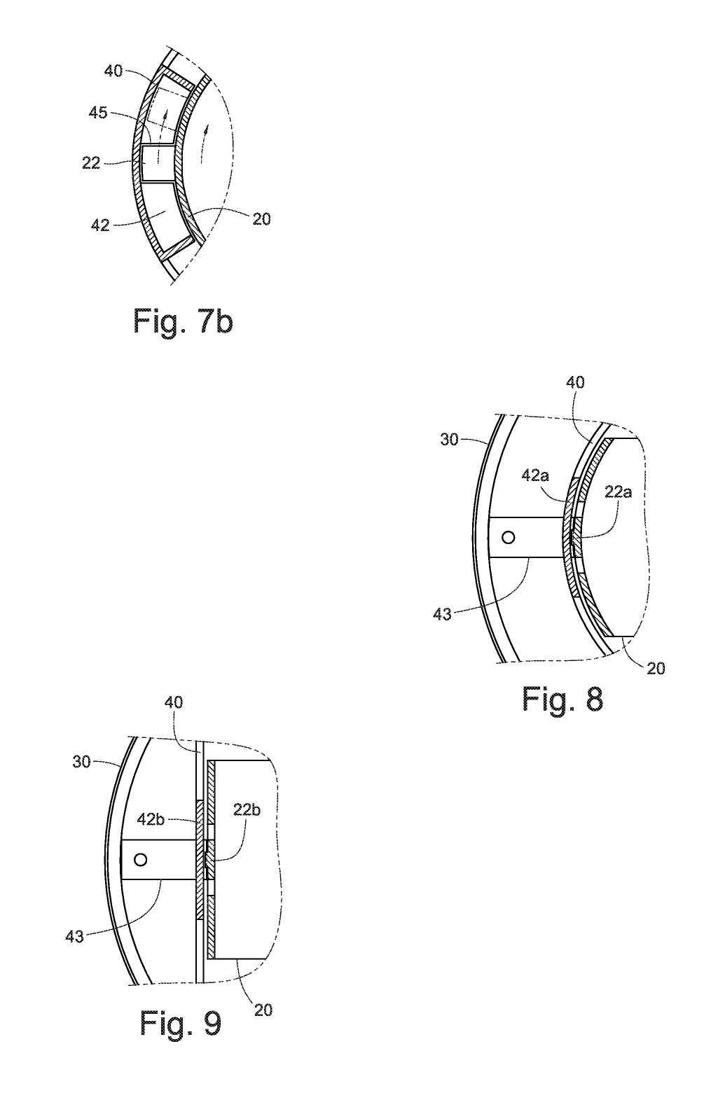

Referring to FIG. 7a and FIG. 7b, the clamping portion 22 can be convex teeth formed on the fins on both sides of the cover body 20, and the limiting portion 42 can be a groove formed by the fins on both sides of the embedding base 40 extending along the axial direction of the flow passage 13. The limiting portion 42 is formed with at least one opening 45. The opening 45 can be formed by the two ends of the limiting portion 42 extending to the edge of the fins, or be formed inside the limiting portion 42, so that the clamping portion 22 can go through the opening 45 into the limiting portion 42. And by turning the embedding base 40, the clamping portion 22 can move away from the opening 45, to avoid falling of the clamping portion 22 away from the limiting portion 42 through the opening 45, and consequently to clamp the limiting portion 42.

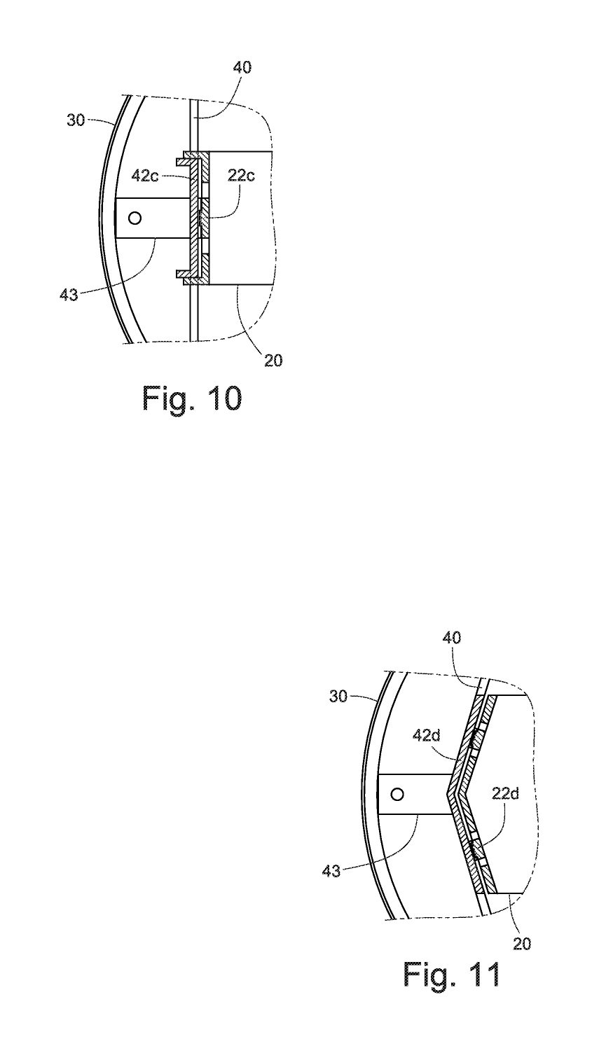

Referring to FIG. 8 to FIG. 11, the clamping portion 22 and the limiting portion 42 can be implemented in multiple corresponding shapes. As shown in FIG. 8, the clamping portion 22a and the limiting portion 42a are in corresponding arc shapes; As shown in FIG. 9, the clamping portion 22b and the limiting portion 42b are in corresponding line shapes; As shown in FIG. 10, the clamping portion 22c and the limiting portion 42c are in corresponding U shapes; As shown in FIG. 11, the clamping portion 22d and the limiting portion 42d are in corresponding V shapes; In this way, the limiting portion 42 can be guided and clamped by the clamping portion 22.

Although the invention has been explained in relation to its preferred embodiment, it is to be understood that many other possible modifications and variations can be made without departing from the spirit and scope of the invention as hereinafter claimed.

1. A concealed sprinkler head cover, comprising:
a sprinkler head body having a substantially horizontal shoulder plane and two symmetric ribs extending downwardly from two sides of the shoulder plane, respectively;
a cover, locked on the sprinkler head body, with a main plate rested on and in direct contact with the shoulder plane, and two ends of the main body respectively formed with a clamping portion, wherein the cover is formed with an upward open groove on the main plate and between the clamping portions;
a cap, made of low-temperature metal and adhered to an embedding base, wherein two ends of the embedding base are respectively formed with a limiting portion, and the embedding base is formed with a downward open groove between the limiting portions;
wherein, two clamping portions of the cover clamp two limiting portions of the embedding base, so that the upward open groove and the downward open groove are communicated with each other to form an air flow passage.

2. The concealed sprinkler head cover as recited in claim 1, wherein the clamping portion is formed by fins on both sides of the cover, and the limiting portion is formed by the fins on both sides of the embedding base.

3. The concealed sprinkler head cover as recited in claim 2, wherein the upward open groove is formed between the fins on both sides of the cover, and the downward open groove is formed between the fins on both sides of the embedding base.

4. The concealed sprinkler head cover as recited in claim 2, wherein the clamping portion is formed on the outside of the fins on both sides of the cover, and the limiting portion is formed on the inside of the fins on both sides of the embedding base.

5. The concealed sprinkler head cover as recited in claim 2, wherein the clamping portion is formed on inside of the fins on both sides of the cover, and the limiting portion is formed on the outside of the fins on both sides of the embedding base.

6. The concealed sprinkler head cover as recited in claim 4, wherein the limiting portion is multiple V-shaped ridges distributed at intervals, and the clamping portion is a snap that can adjust a height of clamping on the V-shaped ridges.

7. The concealed sprinkler head cover as recited in claim 4, wherein the limiting portion is a groove, and the clamping portion is convex teeth that can be embedded into the groove.

8. The concealed sprinkler head cover as recited in claim 4, wherein the shapes of the clamping portion and the limiting portion are corresponding arc shapes, line shapes, U shapes or V shapes.
